(19) United States
(12) Patent Application Publication
(10) Pub. No.: US 2024/0429580 A1
(43) Pub. Date: Dec. 26, 2024

(54) ACTIVE PRESSURE CONTROL PIEZEOELECTRIC MECHANISM FOR IMPROVED BATTERY PERFORMANCE

(71) Applicant: GM Global Technology Operations LLC, Detroit, MI (US)

(72) Inventors: Alexander Millerman, Bloomfield Township, MI (US); Chunhao J. Lee, Troy, MI (US); Yongjie Zhu, Troy, MI (US); Insu Chang, Troy, MI (US); Jun-mo Kang, Ann Arbor, MI (US); Chen-fang Chang, Bloomfield Hills, MI (US)

(21) Appl. No.: 18/341,524

(22) Filed: Jun. 26, 2023

(51) Int. Cl. H01M 50/618; B60L 50/64; H01M 10/42

(52) U.S. Cl. CPC H01M 50/618; B60L 50/64; H01M 10/425; H01M 2220/20

(57) ABSTRACT

A vehicle, a pressure control device and method for controlling a pressure within a battery of the vehicle. The pressure control device includes a support plate, a pressure plate and an actuator. The pressure plate is configured to move with respect to the support plate. The battery is disposed between the support plate and the pressure plate. The actuator changes between a first shape and a second shape to move the pressure plate with respect to the support plate to control the pressure within the battery.

### INTRODUCTION

The subject disclosure relates to increasing a performance of a battery and, in particular, to controlling pressure applied to a battery that operates under high pressure conditions to increase its performance.

A Lithium Metal Battery (LMB) can be used to provide power in an electric vehicle. When the LMB is operated under low pressure conditions, dendrites can grow between the anode and cathode of the battery. These dendrites limit the life span and effectiveness of the LMB. However, dendrite growth can be reduced by operating the LMB under high pressure conditions. Accordingly, it is desirable to provide a method and apparatus for applying high pressure to the battery during its operation.

### SUMMARY

In one exemplary embodiment, a pressure control device for controlling a pressure within a battery is disclosed. The pressure control device includes a support plate, a pressure plate and an actuator. The pressure plate is configured to move with respect to the support plate. The battery is disposed between the support plate and the pressure plate. The actuator is configured to change between a first shape and a second shape to move the pressure plate with respect to the support plate to control the pressure within the battery.

In addition to one or more of the features described herein, the actuator includes a strip of piezoelectric material extending from a first end to a second end, the strip of piezoelectric material being coupled to a control plate at the first end by a first support and coupled to the control plate at the second end by a second support.

In addition to one or more of the features described herein, one of the first end is fixed to the first support and the second end is fixed to the second support, the first end is fixed to the first support and the second end is slidable with respect to the second support, and the first end is slidable with respect to the first support and the second end is slidable with respect to the second support.

In addition to one or more of the features described herein, he actuator further includes a steel strip coupled to the piezoelectric material.

In addition to one or more of the features described herein, the steel strip is biased toward one of the first shape and the second shape.

In addition to one or more of the features described herein, the control plate is stationary with respect to the support plate.

In addition to one or more of the features described herein, the pressure control device further includes a pressure sensor configured to measure a pressure within the battery and a controller configured to control a current through the actuator based on the pressure.

In another exemplary embodiment, a method of controlling a pressure within a battery is disclosed. The method includes disposing the battery between a support plate and a pressure plate configured to move with respect to the support plate and energizing an actuator to change between a first shape and a second shape to move the pressure plate with respect to the support plate to control the pressure within the battery.

In addition to one or more of the features described herein, the actuator includes a strip of piezoelectric material extending from a first end to a second end, the strip of piezoelectric material being coupled to a control plate at the first end by a first support and coupled to the control plate at the second end by a second support.

In addition to one or more of the features described herein, one of the first end is fixed to the first support and the second end is fixed to the second support, the first end is fixed to the first support and the second end is slidable with respect to the second support, and the first end is slidable with respect to the first support and the second end is slidable with respect to the second support.

In addition to one or more of the features described herein, the actuator further includes a steel strip coupled to the piezoelectric material.

In addition to one or more of the features described herein, the steel strip is biased toward one of the first shape and the second shape.

In addition to one or more of the features described herein, the control plate is stationary with respect to the support plate.

In addition to one or more of the features described herein, the method further includes measuring a pressure within the battery using a pressure sensor and controlling a current through the actuator based on the pressure.

In yet another exemplary embodiment, a vehicle is disclosed. The vehicle includes a battery and a pressure control device. The pressure control device includes a support plate, a pressure plate configured to move with respect to the support plate, wherein the battery is disposed between the support plate and the pressure plate, and an actuator configured to change between a first shape and a second shape to move the pressure plate with respect to the support plate to control the pressure within the battery.

In addition to one or more of the features described herein, the actuator includes a strip of piezoelectric material extending from a first end to a second end, the strip of piezoelectric material being coupled to a control plate at the first end by a first support and coupled to the control plate at the second end by a second support.

In addition to one or more of the features described herein, one of the first end is fixed to the first support and the second end is fixed to the second support, the first end is fixed to the first support and the second end is slidable with respect to the second support, and the first end is slidable with respect to the first support and the second end is slidable with respect to the second support.

In addition to one or more of the features described herein, the actuator further includes a steel strip coupled to the piezoelectric material.

In addition to one or more of the features described herein, the steel strip is biased toward one of the first shape and the second shape.

In addition to one or more of the features described herein, the vehicle further includes a pressure sensor configured to measure a pressure within the battery and a controller configured to control a current through the actuator based on the pressure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an electric vehicle, in accordance with an exemplary embodiment;

FIG. 2 shows a battery system for a battery in an exemplary embodiment;

FIG. 3 shows a close-up side view of the actuator in a non-energized state;

FIG. 4 shows a close-up side view of the actuator in an energized state;

FIG. 5 shows a perspective view of the actuator in a non-energized state in a first embodiment;

FIG. 5A shows a second support and slot of the actuator;

FIG. 6 shows a perspective view of the actuator in an energized state in the first embodiment;

FIG. 7 shows a perspective view of the actuator in a second embodiment;

FIG. 8 shows a side view of the pressure control device, in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

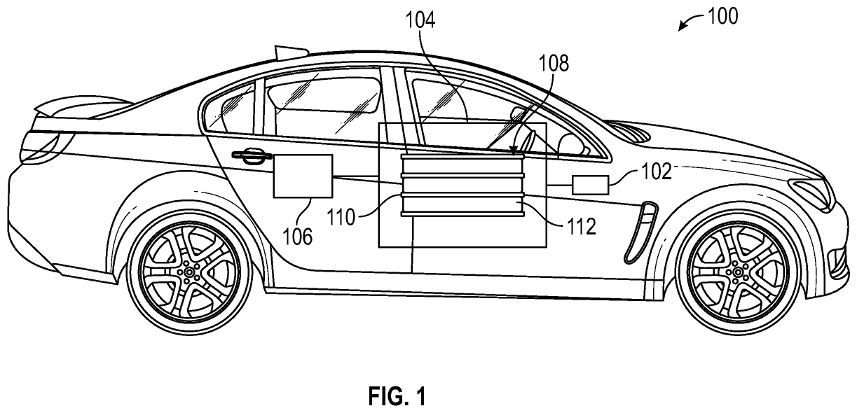

In accordance with an exemplary embodiment, FIG. 1 shows an electric vehicle 100. The electric vehicle 100 includes an electric motor 102 a battery system 104 and a controller 106. The battery system 104 includes a battery 108 that includes anodes 110 and cathodes 112 that that are susceptible to forming dendrites during operation at standard pressures or ambient pressures. The dendrites diminish the quality of operation of the battery 108. In various embodiments, the battery 108 is any battery that requires high pressure conditions for operation, such as a lithium metal battery (LMB). The battery system 104 includes a device that applies a pressure to the battery 108 and is able to adjust or control the pressure as desired.

The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of operating the battery system 104 so as to apply a pressure at the battery 108, as desired.

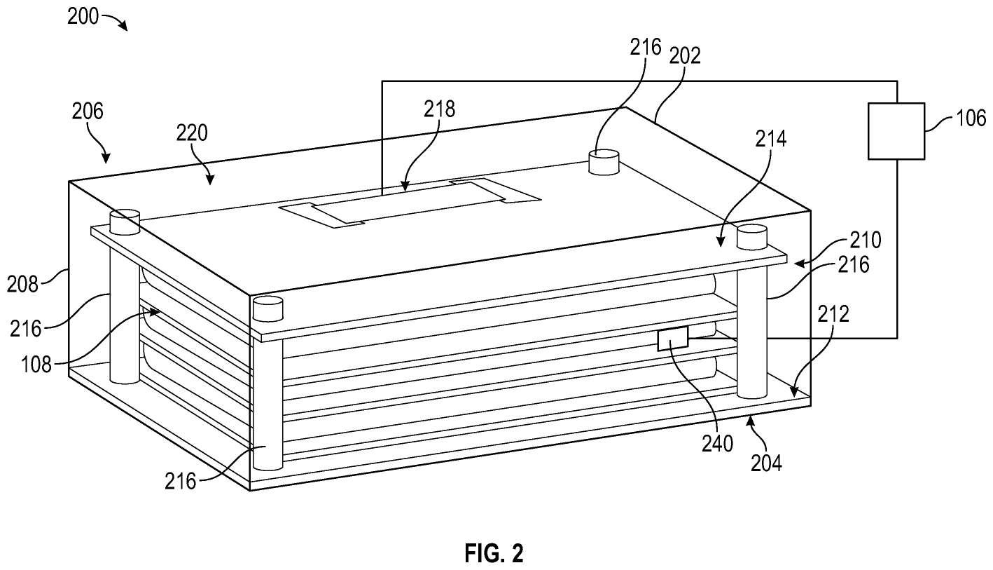

FIG. 2 shows a battery system 200 for a battery 108 in an exemplary embodiment. The battery system 200 includes a housing 202 that houses the battery 108. The housing 202 can have a bottom surface 204, a top surface 206 and side walls 208. A pressure control device 210 for the battery 108 is disposed inside the housing 202. The pressure control device 210 includes a support plate 212 upon which the battery 108 is disposed, a pressure plate 214 that is movable with respect to the support plate, and posts 216 that guide a movement of the pressure plate in a direction either towards or away from the support plate. The support plate 212 can be the same as the bottom surface of the housing 202. The support plate 212 is placed against a first side of the battery 108, and the pressure plate 214 is placed against a second side of the battery 108 that is opposite the first side. The pressure plate 214 can be moved toward the support plate 212 to increase a pressure applied on the battery 108. The pressure plate 214 can be moved away from the support plate 212 to decrease the pressure applied on the battery 108.

An actuator 218 is disposed at a location above the pressure plate 214. The actuator 218 includes a piezoelectric material that changes shape when an electric current is applied. The piezoelectric material can change between a first shape (when no current is applied to the piezoelectric material) and a second shape (when full current is applied to the piezoelectric material). The piezoelectric material can be referred to as energized when current is applied and non-energized when no current is applied. The current can be supplied from a voltage source (not shown) applying a voltage across the ends of the piezoelectric material. The first shape can be a planar shape, while the second shape is an arced shape, which takes up a greater space than the first shape. The actuator 218 can be coupled to or affixed to a control plate 220 that is held at a fixed location with respect to the support plate 212. In various embodiments, the control plate 220 can be the top surface 206 of the housing 202. When in the first shape (i.e., planar shape), the actuator 218, exerts little or no force on the pressure plate 214. When energized into taking the second shape (i.e., the arced shape), the piezoelectric material expands out of the plane to exert a force on the pressure plate 214 to thereby increase a pressure within the battery 108.

A pressure sensor 240 is configured to measure the pressure within the battery 108. The pressure can be sent to the controller 106 or other suitable processor. The controller 106 can control an operation of the motor based on the detected pressure within the battery 108 by controlling an amount of current flowing through the piezoelectric material.

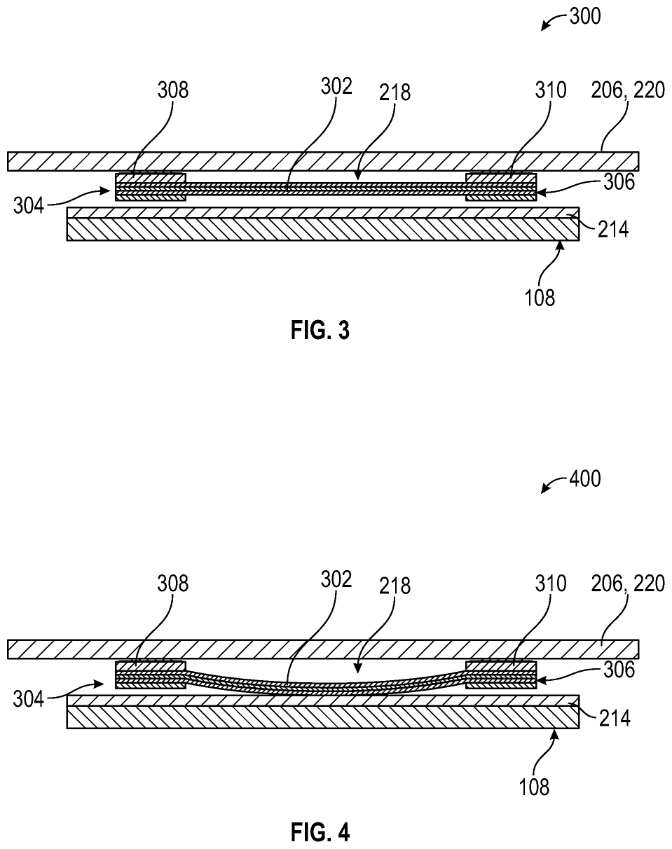

FIG. 3 shows a close-up side view 300 of the actuator 218 in a non-energized state. The actuator 218 includes a strip 302 of piezoelectric material extending from a first end 304 to a second end 306. The first end 304 is coupled to a first support 308 and the second end 306 is coupled to a second support 310. The first support 308 is coupled to the control plate 220 at a first location and the second support 310 is coupled to the control plate at a second location. The first end 304 can be fixed in place by the first support 308 and the second end 306 can be fixed in place by the second support 310. Without any current flowing through the piezoelectric material, the strip 302 forms a first shape which is planar.

In an embodiment, the strip 302 has a bi-morphic layer including two layers of different piezoelectric materials that expand at different rates when energized by a current, thereby producing a bend or an arc in the strip 302. Additionally, the strip 302 can include a layer of steel or steel strip or a layer of other material forming a spring that amplifies a displacement of the strip 302 when energized. The layer of steel can be biased toward an arced shape.

In another embodiment, the strip 302 can include a layer of steel or other material forming a spring that is biased toward a flat or planar shape. In this embedment, the strip 302 naturally (i.e., when no current is applied) resides in an arced shape. The piezoelectric material pulls back on the spring when energized.

FIG. 4 shows a close-up side view 400 of the actuator 218 in an energized state. With a current flowing through the piezoelectric material, the strip 302 takes on a second shape. The second shape includes an arc with a middle part of the material bending away from the control plate 220 and toward the pressure plate 214. In this shape, the strip 302 exerts a force on the pressure plate 214 to cause the pressure plate 214 to move away from the control plate 220 and toward the support plate 212. The amount of current through the strip 302 of piezoelectric material can be controlled to adjust the amount of arc produced in the strip 302 and thus the force applied against the pressure plate 214.

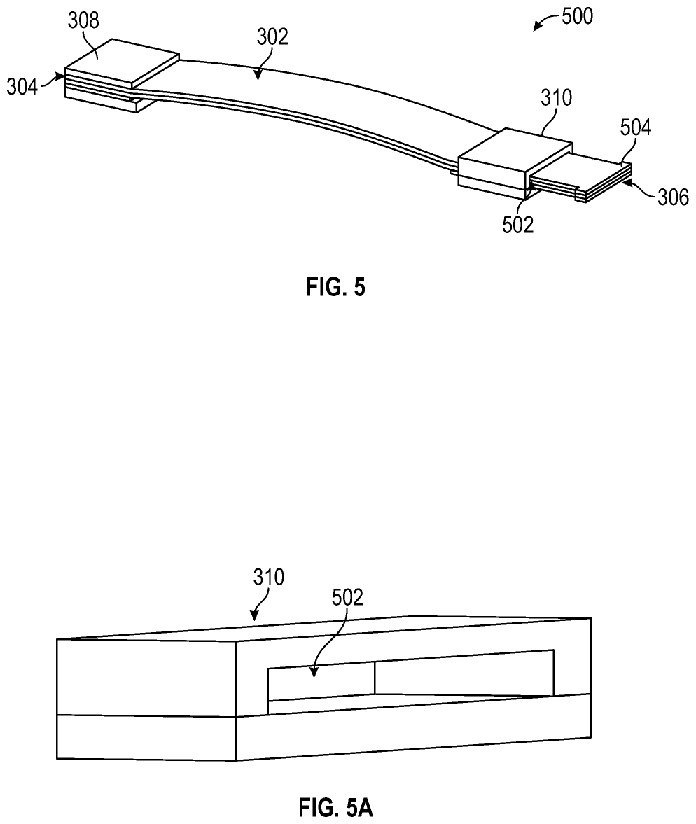

FIG. 5 shows a perspective view 500 of the actuator 218 in a non-energized state in a first embodiment. The first end 304 of the strip 302 is fixed in place by the first support 308. The second support 310 includes a slot 502 through which the second end 306 of the strip 302 is free to move or slide. FIG. 5A shows the second support 310 and slot 502. When the strip 302 is in the planar shape, the second end 306 is fully extended through the slot 502. The second end 306 can have a flanged section 504.

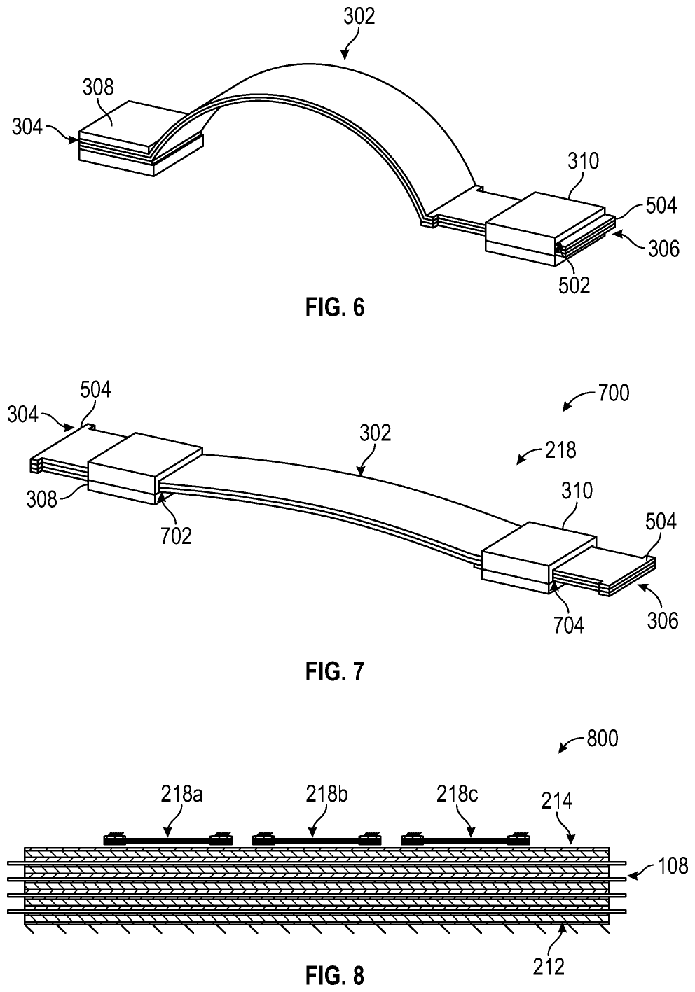

FIG. 6 shows a perspective view 600 of the actuator 218 in an energized state in the first embodiment. As the strip 302 changes to an arced shape, the second end 306 is drawn inward through the slot 502. The flanged section 504 limits the extent to which the second end 306 is withdrawn through the slot 502.

FIG. 7 shows a perspective view 700 of the actuator 218 in a second embodiment. The first support 308 includes a first slot 702 through which the first end 304 of the strip 302 is free to move or slide. The second support 310 includes a second slot 704 through which the second end 306 of the strip 302 is free to move or slide. When the strip 302 is in the planar shape, the first end 304 extends through the first slot 702 and the second end 306 extends through the second slot 704. As the strip 302 changes to an arced shape, the first end 304 is drawn inward through the first slot 702 and the second end 306 is drawn inward through the second slot 704. The first end 304 can have a first flanged section 706 and the second end 306 can have a second flanged section 708, each of which limit the extent to which their respective ends can be withdrawn through their respective slots.

FIG. 8 shows a side view 800 of the pressure control device 210, in another embodiment. The pressure control device 210 includes a plurality of actuators. Three actuators 218a, 218b, 218c are shown for illustrative purposes. Each actuator can be energized independently using independently controlled currents. Thus, different forces can be applied at different locations along the surface of the pressure plate 214, resulting in a differential pressure can be within the battery 108.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A pressure control device for controlling a pressure within a battery, comprising:
a support plate;
a pressure plate configured to move with respect to the support plate, wherein the battery is disposed between the support plate and the pressure plate; and
an actuator configured to change between a first shape and a second shape to move the pressure plate with respect to the support plate to control the pressure within the battery.

2. The pressure control device of claim 1, wherein the actuator includes a strip of piezoelectric material extending from a first end to a second end, the strip of piezoelectric material being coupled to a control plate at the first end by a first support and coupled to the control plate at the second end by a second support.

3. The pressure control device of claim 2, wherein one of: (i) the first end is fixed to the first support and the second end is fixed to the second support; (ii) the first end is fixed to the first support and the second end is slidable with respect to the second support; and (iii) the first end is slidable with respect to the first support and the second end is slidable with respect to the second support.

4. The pressure control device of claim 2, wherein the actuator further comprises a steel strip coupled to the piezoelectric material.

5. The pressure control device of claim 4, wherein the steel strip is biased toward one of: (i) the first shape; and (ii) the second shape.

6. The pressure control device of claim 2, wherein the control plate that is stationary with respect to the support plate.

7. The pressure control device of claim 1, further comprising a pressure sensor configured to measure a pressure within the battery and a controller configured to control a current through the actuator based on the pressure.

8. A method of controlling a pressure within a battery, comprising:
disposing the battery between a support plate and a pressure plate configured to move with respect to the support plate; and
energizing an actuator to change between a first shape and a second shape to move the pressure plate with respect to the support plate to control the pressure within the battery.

9. A method of claim 8, wherein the actuator includes a strip of piezoelectric material extending from a first end to a second end, the strip of piezoelectric material being coupled to a control plate at the first end by a first support and coupled to the control plate at the second end by a second support.

10. The method of claim 9, wherein one of: (i) the first end is fixed to the first support and the second end is fixed to the second support; (ii) the first end is fixed to the first support and the second end is slidable with respect to the second support; and (iii) the first end is slidable with respect to the first support and the second end is slidable with respect to the second support.

11. The method of claim 9, wherein the actuator further comprises a steel strip coupled to the piezoelectric material.

12. The method of claim 11, wherein the steel strip is biased toward one of: (i) the first shape; and (ii) the second shape.

13. The method of claim 9, wherein the control plate is stationary with respect to the support plate.

14. The method of claim 8, further comprising measuring a pressure within the battery using a pressure sensor and controlling a current through the actuator based on the pressure.

15. A vehicle, comprising:
a battery; and
a pressure control device, comprising:
a support plate;
a pressure plate configured to move with respect to the support plate, wherein the battery is disposed between the support plate and the pressure plate; and
an actuator configured to change between a first shape and a second shape to move the pressure plate with respect to the support plate to control the pressure within the battery.

16. The vehicle of claim 15, wherein the actuator includes a strip of piezoelectric material extending from a first end to a second end, the strip of piezoelectric material being coupled to a control plate at the first end by a first support and coupled to the control plate at the second end by a second support.

17. The vehicle of claim 16, wherein one of: (i) the first end is fixed to the first support and the second end is fixed to the second support; (ii) the first end is fixed to the first support and the second end is slidable with respect to the second support; and (iii) the first end is slidable with respect to the first support and the second end is slidable with respect to the second support.

18. The vehicle of claim 16, wherein the actuator further comprises a steel strip coupled to the piezoelectric material.

19. The vehicle of claim 18, wherein the steel strip is biased toward one of: (i) the first shape; and (ii) the second shape.

20. The vehicle of claim 15, further comprising a pressure sensor configured to measure a pressure within the battery and a controller configured to control a current through the actuator based on the pressure.
